(19) United States
(12) Patent Application Publication
(10) Pub. No.: US 2002/0097221 A1
(43) Pub. Date: Jul. 25, 2002

(54) Transparent input/display device

(76) Inventors: Kofi Schulterbrandt, Mitchelleville, MD (US); Rafael Alejandro Samuels, Takoma Park, MD (US); William M. Perkins, Anchorage, AK (US)

Correspondence Address: KOFI SCHULTERBRANDT, 2102 ARCTIC FOX DR., MITCHELLEVILLE, MD, 20721, US

(21) Appl. No.: 09/764,388

(22) Filed: Jan. 19, 2001

Related U.S. Application Data
(60) Provisional application No. 60/250,158, filed on Dec. 1, 2000.

(51) Int. Cl. G09G 5/08

(52) U.S. Cl. 345/157

(57) ABSTRACT

The present invention is drawn to a device having a transparent display superimposed over an object so that a user may view an object through the transparent display and may chose a point on the device that corresponds visually with a point on the object and the location of the chosen point is communicated between the device and a computer and a computer display displays where the object was touched.

### BACKGROUND OF THE INVENTION

1. Field of the Invention

The present invention relates to an information processing apparatus for inputting data (including commands, items, coordinate points of external images or objects etc.) by using an integrated display/input device consisting of a transparent input device and a transparent display device.

2. Description of the Related Art

The integrated input/display device of the prior art superimposes a display device and a transparent tablet serving as a coordinate input device. In the prior art, the user inputs data to an information processing apparatus, for example, by pointing out a location on the transparent tablet with use of a special pen while seeing the data or image displayed on the display device through the transparent tablet. The apparatus of the prior art, however, is incapable of conducting certain tasks involving external objects.

One embodiment of the present invention, in conjunction with a computer, performs the functions of a typewriter. It is frequently desirable to create machine generated writing on an object external to the device, for example a sheet of paper. For many years, those needing to accomplish this task have used typewriters. A typewriter can produce characters on a sheet of paper in a more neat and desirable way than hand written productions are produced. Typewritten documents have even become the standard for formal document production.

The introduction of computers has made type writers less important and as a result less popular. A user who is desirous of generating a typewritten document can do so much more easily using a computer. Readily available word processing software in combination with the storage and display capability of a computer allows a user to create, store, display the entire document, edit the document and print the document after the user is satisfied with what has been displayed.

Typewriters generally have no storage capability and editing can be slow and painful. Most typewriters have expendable ribbons and ribbon erasers. In addition, typewriters have a number of moving parts that make design, reliability and maintenance difficult.

In spite of the drawbacks, and as useful as computers are, typewriters still perform a function that computers cannot duplicate. Even in offices where every user has a computer, several typewriters are usually available even if they are only located at special work stations. These typewriters are used mostly for completing forms. Computers can generate forms from scratch but that is not the feature that is needed for filling out hard copy forms. Computers cannot fill in blank lines on an existing piece of paper because there is no easy way to tell the computer where the blank lines are on varying forms.

The prior art superimposes an input device over a display such as a liquid crystal display so that images displayed on the liquid crystal display may be chosen by selecting a point on the input device that corresponds visually with the displayed image. The display screen is an array of pixels which each has a corresponding coordinate position. Each image on a display is made up of a subset of the total array of pixels and therefore also corresponds to an array of coordinates. Each input device also has an array of points that may be chosen. A particular image on the display is chosen when the viewer chooses a point on the input device that corresponds with the coordinate of a pixel in the subset associated with that image displayed on the display screen. These computer features are still inadequate to identify a point on an external object.

For example, a user completing a form may desire to generate characters on a computer monitor using word processing software, insert the object into a printer, print the characters from the monitor onto the object using the word processing sortware and hope the characters are printed in the correct location on the object.

The present invention solves this problem by creating an apparatus with which a user can identify the locations on a form where characters need to be placed by communicating such locations to a computer to create those characters. The computer can then create the chosen characters in the desired corresponding location on the computer monitor, and then the form can be inserted into a printer for the characters to be printed on the form in the desired locations. In this way, the flexibility of computer generated documents can be extended to preparation of external hard copy forms. More generally, the present invention allows a user to choose a point on an object and communicates the coordinates of that point to a computer to be processed.

In addition to the type writer function, another application of the present invention uses the claimed device to choose a point on an object and communicate the coordinates of the chosen point to a computer running Computer Aided Design software. In this embodiment of the present invention the object or an image thereon may be duplicated by picking points on the object or on the image and processing those points using the software. For example, lines, arcs, circles or other shapes may be drawn based on these chosen points until the shapes, which are superimposed over the object, trace and so duplicate the object.

### SUMMARY OF THE INVENTION

An object of the present invention is to provide a transparent device and choosing meand positioned relative to an object through which a viewer can see the object and choose a point on the device or choosing means that visually corresponds to a point on the object. A further object of the invention is to provide the device with a display feature which can display on the device, the location where the device was touched so that when the image is viewed through the transparent device, the viewer will know which points on the object have already been chosen on the device. In the embodiment where the device duplicates the functions of a typewriter, the display device may display the typed characters beginning at the point where the device is touched.

The combination of the input and display features are accomplished by superimposing a transparent input device over a transparent display so that the combination may be placed in a relative position to an object and the viewer may view the object through the input device and display. When the viewer looks through the input/display and the viewer sees the object and determines a particular point on the object to be chosen, the viewer may then visually associate the choosing means with the point on the object to be chosen. When the viewer locates the choosing means to correspond with the point on the object to be chosen, the superimposed display on the input device indicates the spot where the input device was located at the time of choosing.

The device can also record the coordinates of locations where the device has been touched. These coordinates can be communicated to a computer so that the device may work in conjunction with existing computer software programs. For example, the device may be used in conjunction with a word processor to perform the function of a typewriter or with a Computer Aided Design Program (CADP) to trace a drawing on a sheet of paper by choosing points on the sheet of paper and using the software's features to fill in lines, arcs, circles, etc., based on the coordinates of the chosen points.

The present invention unlike the prior art is concerned with correlating a position on the input device with an external object such as a piece of paper like a form which has to be filled out. In this embodiment the invention is utilized similarly to a typewriter. The form to be completed is placed next to the transparent input/display. The user then looks through the input/display device and identifies a point on the form to be chosen, for example the place at the beginning of a blank line where the cursor should begin to type a name or a date. The viewer then utilizes a choosing instrument such as a finger or a light pen to choose the point on the input device which corresponds visually with the point on the object to be chosen. The display then indicates the place where the choosing object was located at the time of choosing. The input/display device also communicates the coordinates of chosen points between the device and a computer and the position of the cursor displayed on the input/display may be further adjusted by the arrow keys of the keyboard to further position the cursor more accurately. The choosing device may also be a mouse which controls the position of a cursor displaying on the display device of the invention. When the choosing device is a cursor of a mouse, obviously no transparent input device is needed because the location of the cursor is already known at the time of choosing.

In the embodiment of the present invention where the input/display device is used as a typewriter function, the coordinate that is chosen by the choosing device is transferred to, for example, a computer running word processing software. The computer may then use this coordinate information to place a cursor on the computer's monitor in a place on the computer monitor that corresponds to the place the cursor appears on the display/input device. In other words, simultaneously, the display of the input/display device and the computer monitor displays a cursor at the coordinate where the choosing device has chosen an input device coordinate. The cursor is now being displayed on the input/display device as well as in the corresponding location on the computer monitor. The user may now type any characters available when using the word processor and in any font and point size. The available characters appear on the computer monitor and on the input/display device. The user may see the image of a filled out form on the input/display device because the display is superimposed over the actual form.

In the embodiment of the present invention wherein the input/display device is used as a tracer, a drawing on an object is placed nest to the device. The viewer may then look through the device and see the drawing and choose a point on the input/display device that corresponds visually to a point on the drawing. If the viewer chooses another point in the same way, the coordinates can be communicated to a computer, for example, running Computer Aided Design (CAD) software so that the points may be connected by a line. If a curve is to be drawn, the user may choose two or more points on the curve and a curve generating feature of the CAD software can be used to duplicate the curve in the object. The points lines and curves may be displayed on the computer monitor as well as on the input/display device. Like the typewriter application, the viewer can see the portion of the object that has already been traced because the points, lines and curves that are generated appear superimposed over the actual object or image. Such a duplication enables the user to substantially reproduce a drawing with accurate perspective and proportion.

The advantage to inputting an image point by point as opposed to scanning the object into a CAD software is that the user controls the structure of the drawing. For example, if a rectangle is scanned into a CAD program, the scanning software must decide whether to enter the rectangle as one unit or as four lines. A subsequent editor of the rectangle then has to first determine in what form the rectangle is stored. If a line on the rectangle is to be erased, the user must determine if erasing the line will erase the entire rectangle, or if the user will first have to explode the rectangle before erasing the line. In the present invention the user has created the entire drawing personally and need not spend time determining the form of scanned images.

In another embodiment of the present invention, a form may be scanned and displayed on a computer monitor as a background. Characters may then be displayed on the computer monitor superimposed over the background which displays the scanned form. The characters are typed on the places where the form is to be filled out. The viewer sees a form that is filled out because characters are superimposed over the form background. The hard copy of the form that has been scanned may now be placed in a printing device. The print function in the word processing software is now chosen to print the characters which have been appropriately placed on the monitor onto the hard copy completing the form. Word processing software may be modified to simply display a form as the working background rather than the common solid color (for example, blue or gray) utilized by most word processing software packages

### BRIEF DESCRIPTION OF THE DRAWINGS

FIG. 1 shows schematically the structure of an information processing apparatus having a conventional integrated display/input device;

FIG. 2 shows a plan view of the device and its display and coordinate ranges.

FIG. 3 is a cross-sectional view showing the structure of the integrated display/input device;

FIG. 4 is a block diagram showing the structure of an integrated display/input device employed in an information processing apparatus according to an embodiment of the present invention;

FIG. 5 shows a plan view of the input/display device;

FIG. 6 shows a cross sectional view of the choosing device;

FIG. 7 is a cross sectional view of the input/display device;

FIG. 8 shows the structure of the Ram of FIG. 4;

FIG. 9 is a perspective view of the integrated input/display apparatus having a frame for holding the apparatus and a stand for vertical operation;

FIG. 10 is a cross-sectional view of the input/display apparatus held by a frame and arranged in proximity to a front, back and side light sources.

FIG. 11A is a perspective view of a sheet of paper having a form printed on it;

FIG. 11B is a perspective view of the input/display apparatus having a frame with the sheet of 6A being inserted therein;

FIG. 11C is a perspective view of the input/display apparatus having a frame with the sheet of FIG. 6A completely inserted therein;

FIG. 12 is a perspective view of the input/display apparatus, a choosing device, a computer CPU and a computer monitor showing a cursor superimposed on the apparatus in the place to type a character being chosen by the choosing device and simultaneously showing another cursor in the corresponding place on the computer monitor.

FIG. 13 is a perspective view of the input/display apparatus, a choosing device, a computer CPU, a computer monitor and a keyboard showing the cursor of FIG. 12 at the end of a line of typed characters superimposed over the form of FIG. 6A and simultaneously displayed on the computer monitor in a corresponding place.

FIG. 14 is a perspective view of the form of FIG. 11A being inserted into a printing device with the form not yet filled out and the same form being discharged from the printer device with the form filled out.

### DETAILED DISCRIPTION OF THE PREFERRED EMBODIMENT

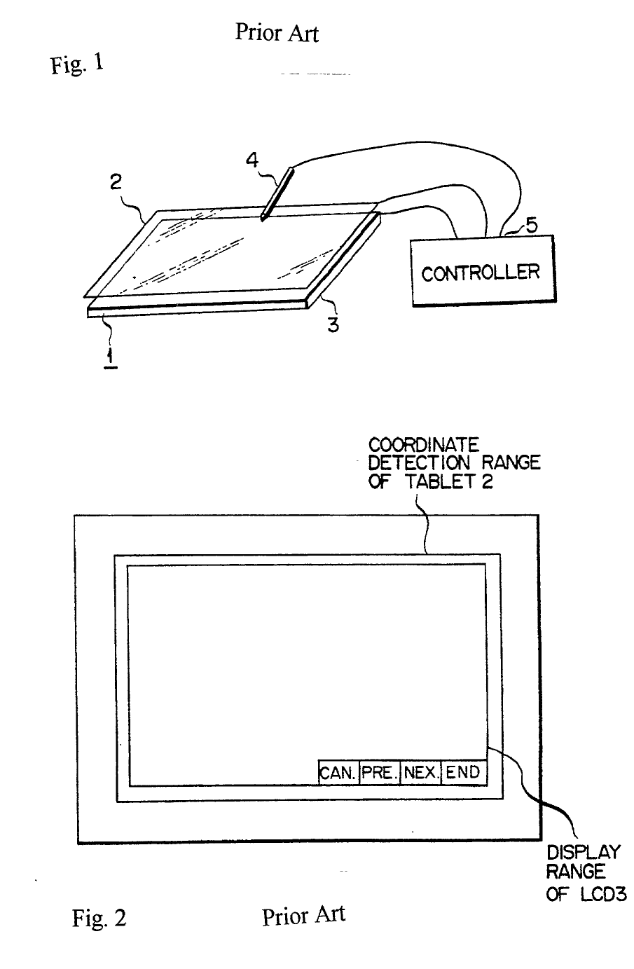

The present invention is drawn to a device and method of mapping a point on an object to a point on the device, using a choosing instrument, by choosing a point on the device or choosing means which visually corresponds to the point on the object. FIG. 1, labeled “Prior Art”, is an illustration of a prior art device as disclosed in U.S. Pat. No. 5,177,328 which is incorporated herein by reference. The apparatus in the prior art has an integrated display/input device 1 which consists of a transparent tablet 2 having a coordinate input device superimposed over a liquid crystal display (LCD) 3. The apparatus further comprises a choosing device 4 for touching the transparent tablet 2.

The choosing device in the present invention can be a mouse, a light pen or another electronic or non-electronic pointer. The choosing feature may further utilize directional keys of a computer keyboard. For example, after an image, flagging the position of a chosen point, is displayed on the LCD 3, its position may be further pin point positioned on the display device by using directional keyboard arrows. The location where the tablet 2 is touched is recognized by the display/input device 1 and is recorded and transmitted to the controller 5 to be processed. The controller can be the CPU of a computer.

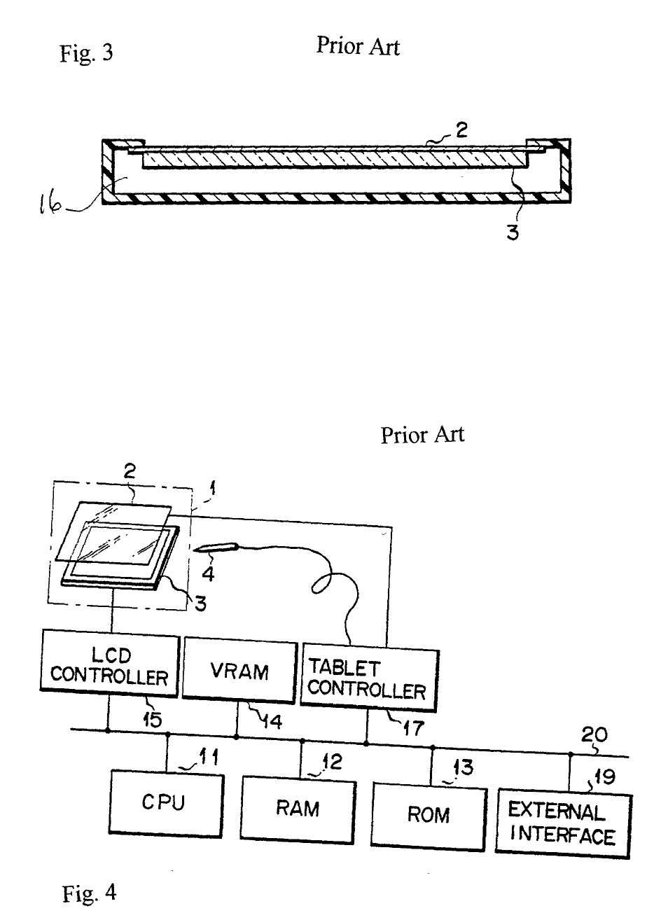

FIG. 3, also labeled prior art, shows a cross sectional view of the apparatus having a casing 10 that forms a frame around the apparatus. The casing may be of a different form or shape and may support the device in varying configurations. FIG. 4 shows a box schematic of the apparatus and an integrated display/input device 1 comprising a transparent tablet 2 situated on the screen of the LCD 3.

A user can see the display image of the LCD 3 through the transparent tablet 2. FIG. 7 shows the transparent tablet 2 which comprises a glass plate and transparent electrodes (X-electrodes and Y-electrodes). The electrodes existing along X- and Y-axes intersecting at right angles to each other, the electrodes can be provided in the glass plate 2.

A choosing instrument is used to point a desired location on the transparent tablet 2 that visually corresponds with an object located below the tablet 2 and/or the LCD 3. The choosing device/pen 4 contains a switch at its tip portion. The switch is turned on when its tip portion is pressed, and the switch is tuned off when its tip portion is not pressed. A pulse voltage is applied to the electrodes within the transparent tablet 2, and the X-Y coordinates of the location pointed by the choosing device 4 are detected by electrostatic induction. The input device can also work with other existing coordinate detection technology. The transparent tablet 2 and the choosing device 4 are controlled by a tablet controller 17 (shown in FIG. 4 described later). The LCD 3 is controlled by an LCD controller 15.

The LCD 3 is able to display a desired image and a given point on portions of the transparent tablet 2. The desired position is pointed to by the choosing device 4, whereby both data display and data input are carried out at one coordinate area.

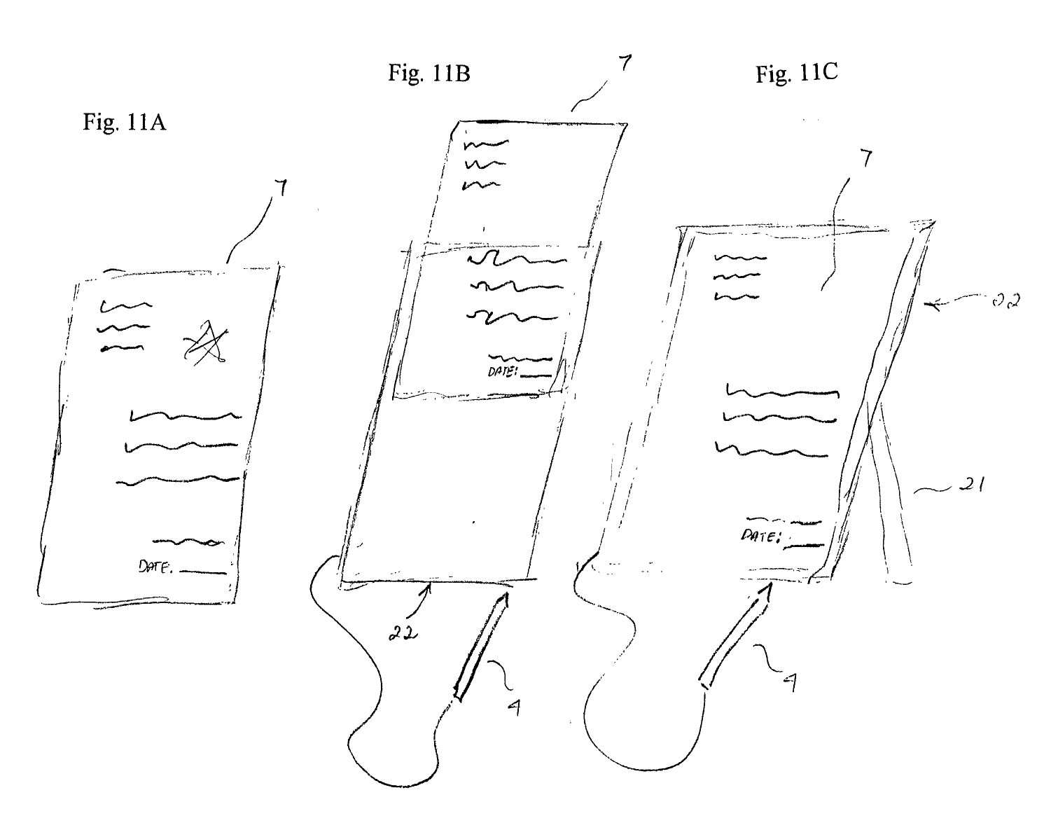

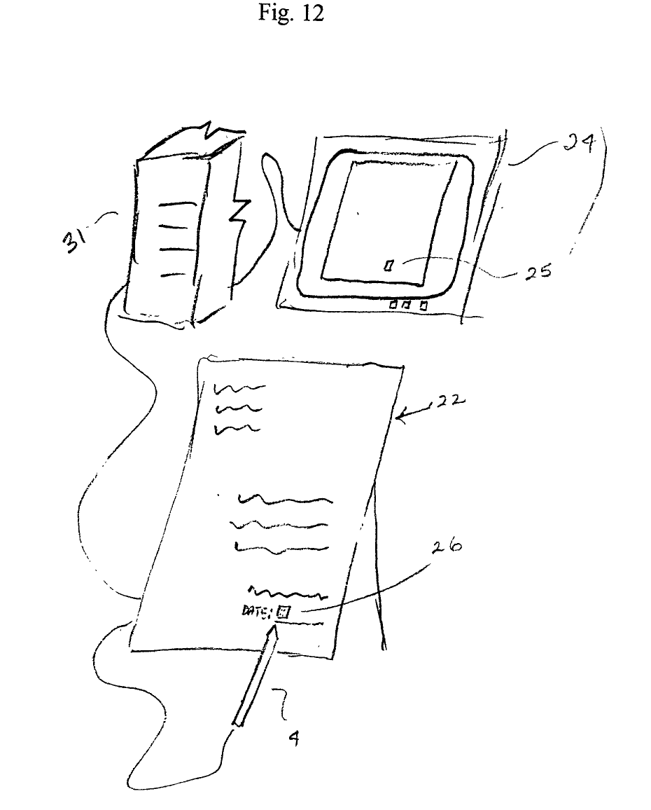

Shown as in FIG. 11, a CPU 11 controls the entire information processing apparatus. A RAM 12 is capable of performing data read/write and stores algorithmic programs and various data for determining the operation of the CPU 11. The RAM 12 stores programs, data relating to the locations (display range) of icons to be displayed on the LCD 3, and other data. The details of the RAM 12 will be described later. On the basis of the data stored in the RAM 12, the particular item or icon which corresponds to the point location identified is determined by the choosing device 4.

A ROM 13 is a read-only memory for storing a diagnosing program to be run, a boot program for starting the information processing apparatus etc., after the information processing apparatus has been switched on. A VRAM 14, is a bit map memory for storing display data. The LCD controller 15 controls display data transfer from the VRAM 14 to the LCD 3, display data transfer from the CPU 11 to the VRAM 14, etc. A tablet controller 17 controls the scan of X- and Y-electrodes of the transparent tablet 2, the voltage detection (in the case of an electrostatic coupling system) of the location pointed by the choosing device 4, generation of XY coordinate data, and transmission of XY coordinate data to the CPU 11. An external interface 19 controls transmission of data between the main apparatus and an external apparatus on an as-needed basis. These components are mutually connected by a bus 20. The components described may be replaced by equivalent components of a computer.

The illustration of FIG. 4 shows a perspective view of the present invention. The reference numbers of FIG. 4 which also appear in FIGS. 1, 2 and 3, labeled “Prior Art”, consistently refer to the same feature in both of the present invention and the prior art. The illustration of FIG. 1 shows a display/input device 1 overlaid with a transparent tablet 2 and a frame 10 which holds the display/input device 1 and the transparent tablet 2 in a superimposed relationship with one another. The frame may have a stand up picture frame type arrangement or may be arranged flat on a table or in another orientation. The frame may also have no back panel or a transparent back panel so that it may be laid over an object to be viewed. An open space 16 if formed between the back panel of frame 10 and the display/input device 1. If the object to be mapped is a sheet of paper with writing thereon or another image thereon, the sheet of paper may be inserted into the open space 16. The writing or image may be viewed through the transparent tablet 2 and through the display/input device 1.

An important distinction between the prior art and the present invention is that the display feature of the present invention has a visual correlation function. The display of the present invention may be a LCD that is transparent when none of its pixels are activated. The appropriate pixels may then be activated to display characters on the LCD 3 to, for example, identify the location where the transparent tablet 2 was touched. Because the LCD is superimposed over the sheet, the display is also superimposed over the sheet.

For example, when the device is being used to fill out forms, a sheet with, for example, a name or date to be filled in may be placed in the open space 16. The place on the display/input device is then touched with the choosing device 4. The appropriate pixels are then activated to mark the place where the display/input device is touched. The choosing device 4 may also be used to choose the location on the object where the LCD 3 may display a cursor 26. If the display/input device 1 communicates with a computer running word processing software, a cursor may be placed on the computer monitor 24 in a corresponding place on the monitor 24 as on the display device. The user may begin typing from the place of positioning of the cursor 26. Typed characters 28 then appear on the computer monitor 24 and on the display 3. Because the display 3 is superimposed over the sheet 7, the viewer may see the typed characters 28 superimposed over the sheet 7 in the desired areas.

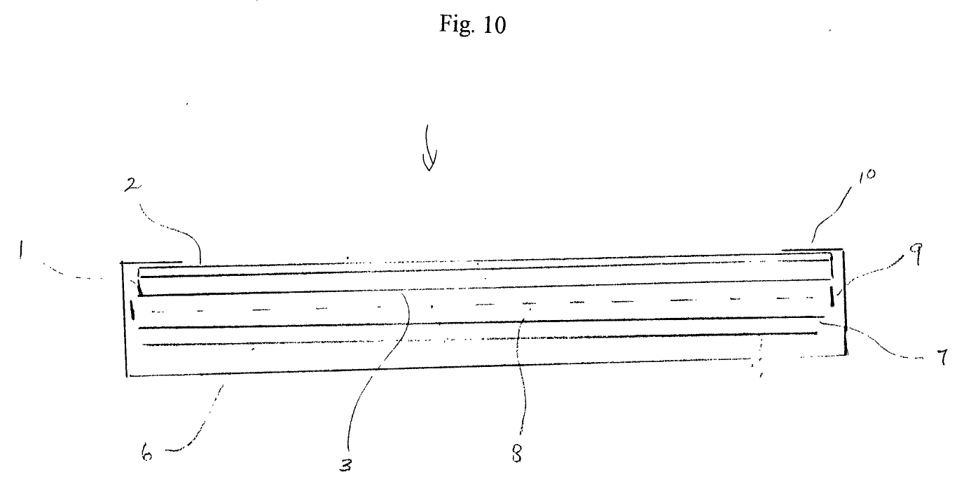

FIG. 10 shows a cross sectional area of the invention. In order to maximize the contrast between activated display pixels and those that are not activated, a sufficient amount of light must be emitted from behind the LCD 3 outward to the viewers eyes. The illustration shows a transparent tablet 2, a display/input device 1 surrounded by a frame 10. FIG. 10 also illustrates a back light source 6, front light source 8 and side light sources 9. Light sources may also be placed on the top and bottom of the object. These light sources illuminate the object 7 to be mapped, which intern reflect the light from the light sources through the LCD 3 display to the viewer's eye. The light sources may also emit light directly through the LCD 3 to the viewer's eye. When the appropriate pixel or group of pixels is activated to block the light from reaching the viewer's eyes, the viewer sees the image of the character formed from activated pixels blocking light from coming back at the viewer. Therefore, the more light that comes through the LCD the larger the contrast will be between the activated pixels forming the image and the unactivated pixels.

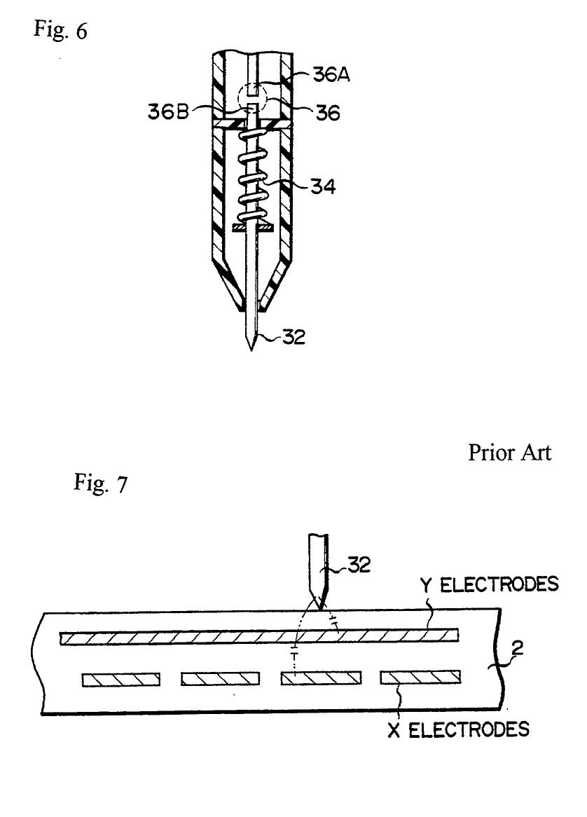

The user may utilize the invention to, for example, complete a form on a sheet of paper more easily and with all of the features available to users of popular word processing software. FIGS. 11, 12 and 13 illustrate how the invention may be used to complete a form. FIG. 6A shows a sheet of paper, for example, a letter whereon a date needs to be placed in the bottom right hand corner. FIG. 11B shows the sheet being inserted into the open space 16 between the transparent display/input device 1 and the back wall of the frame 10. FIG. 11C shows the sheet completely inserted into the mapping device 22.

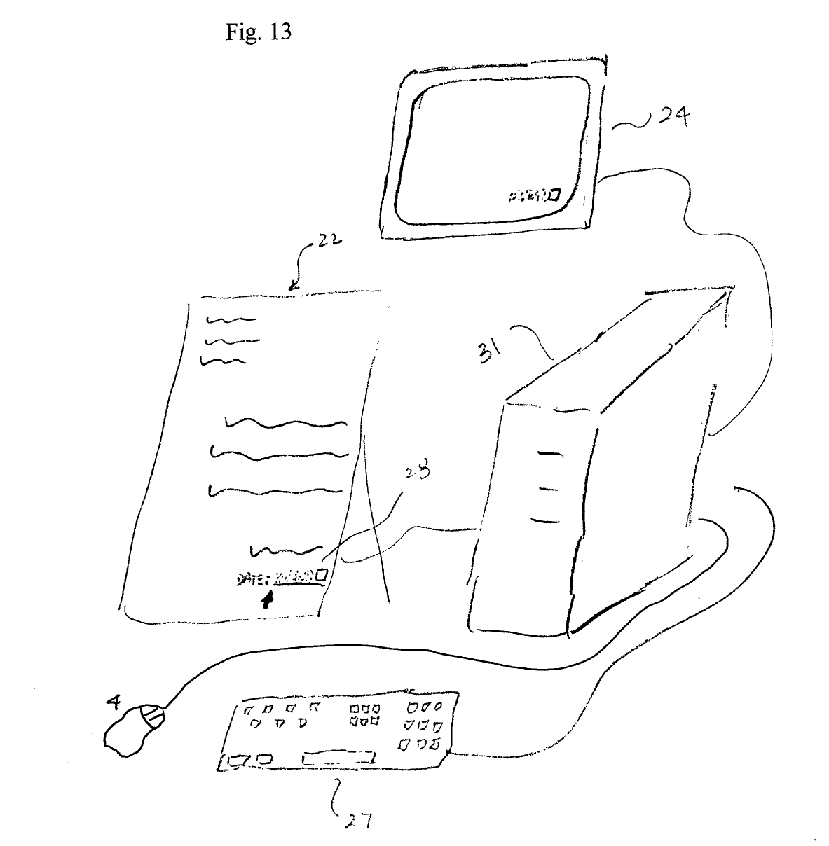

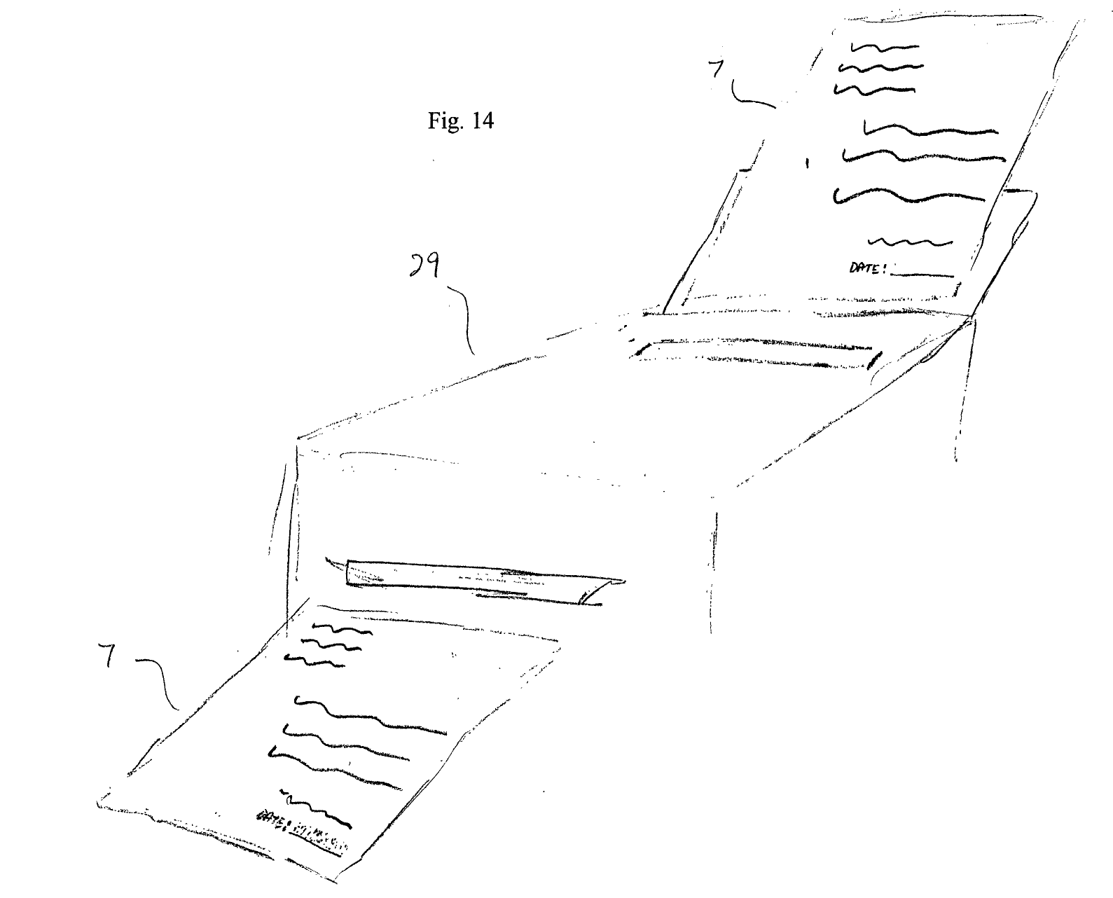

The illustrations of FIGS. 12 and 13 show how the mapping device 22 of the present invention works in conjunction with a computer CPU, monitor, keyboard and printer. FIG. 12 shows the mapping device 22 of the invention communicating with a CPU 23 and a monitor 24. The display shows the choosing device 4 touching the input/display device 1 at the location at the beginning of the line where the date is to be inserted. FIG. 12 also shows the cursor 26 being displayed by the LCD display at the beginning of the line where the date will be inserted. In addition, the illustration shows the cursor 25 on the computer monitor 24 in a corresponding position on the monitor screen 24 as on the device 1.

FIG. 13 shows the mapping device 22 of the present invention connected to a computer CPU 23, a monitor 24 and a keyboard 27. After the cursors 25 and 26 are displayed on the mapping device 22 and the monitor 24 respectively, the keyboard 27 is used to type appropriate characters 28 to fill in the desired date on both of the mapping device 22 and the monitor 24. The typed characters are similarly displayed on both of the display 3 of the mapping device 1 and the monitor 24. The choosing device 4 may be used to choose another location on the input device which visually corresponds to another desired point on the form sheet 7 which has been placed in the mapping device 22. Again, the desired characters 28 may be typed in the desired location on the sheet 7. When all of the desired locations are chosen and the desired characters 28 are typed thereon, the user may view the characters 28 which are superimposed over the form sheet 7 placed in the mapping device 22.

The monitor 24 now also displays the characters in the desired locations on the word processor page displayed on the monitor 24 The user can now remove the sheet from the mapping device 22 and place the sheet into a printer 29. The characters can now be inserted in the appropriate place on the form sheet by indicating the print function in the word processing software.

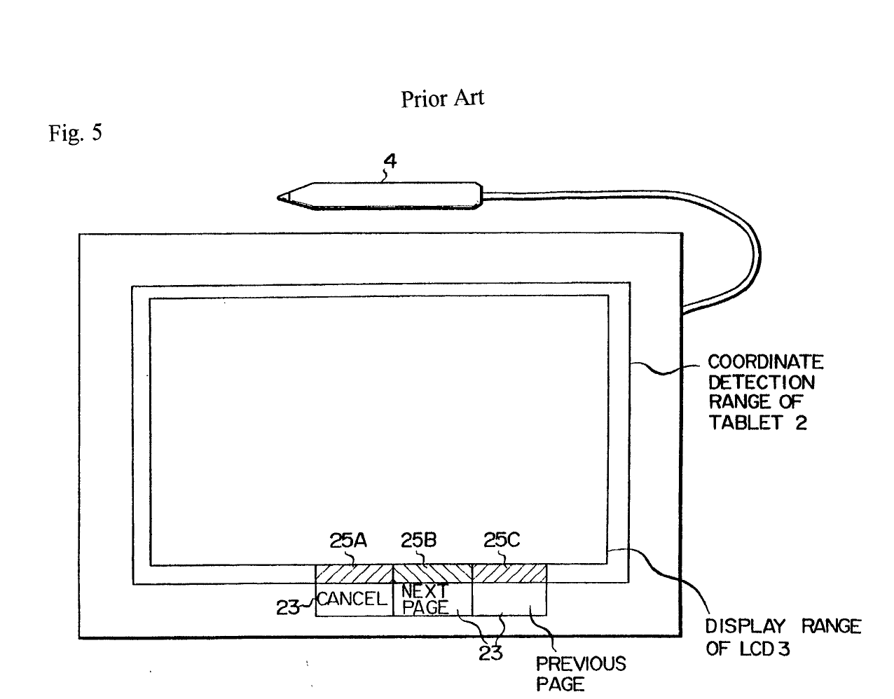

The electronic structure will now be described. FIG. 5. is a plan view of the integrated display/input device 1 according to this embodiment. As is shown in FIG. 5, the coordinate detection range (the range within which coordinates can be detected) of the transparent tablet 2 is greater than the display range (the range within which data can be displayed) of the LCD 3. Selection regions 25A, 25B and 25C are provided on that part of the coordinate detection range which extends beyond the display range of LCD 3. In FIG. 5, the selection region 25A is used for inputting a command “cancel”, the selection region 25B for inputting a command “next page”, and the selection region 25C for inputting and command “previous page”. The upper surface of the casing of transparent tablet 2 bears labels indicating the commands assigned to the regions 25A, 25B and 25C. The cross section of the integrated display/input device 1 is the same as is shown in FIG. 3. Referring to FIG. 6, the data structure in Ram 12 will now be described.

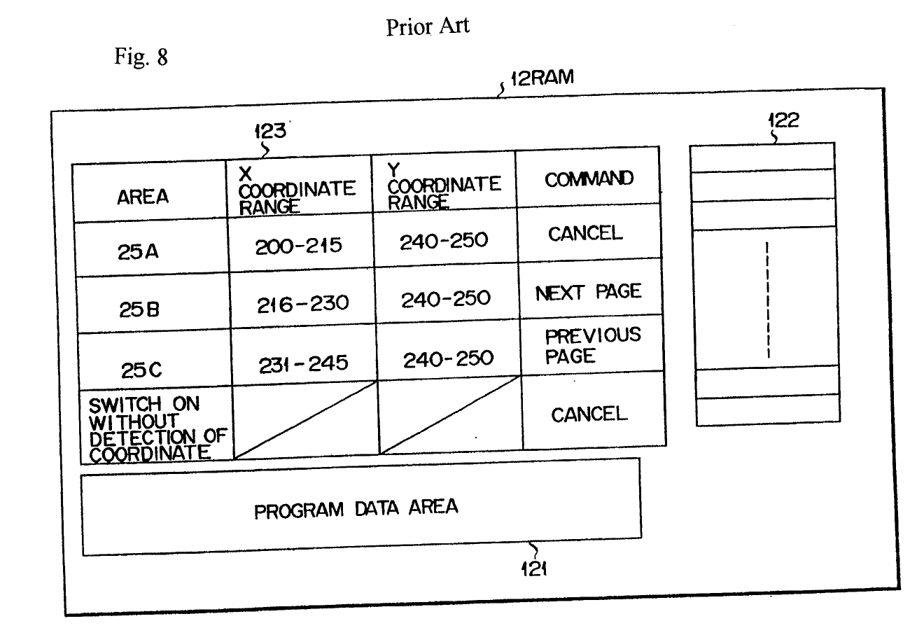

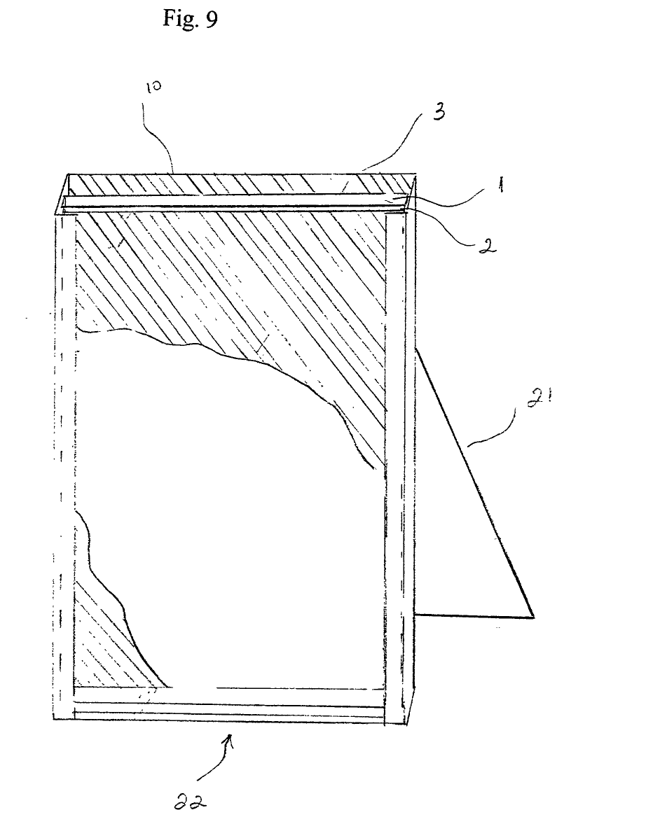

In FIG. 8, the RAM 12 comprises a program/data area 121 for storing application programs and data, a queue area 122, and a command indication area 123. The program/data area 121 stores application programs and data under the processing. The queue area 122 constitutes a first-in-first-out queue, for example. The command indication area 123 stores X-coordinate and Y-coordinate ranges of the selection regions 25A, 25B and 25C and commands assigned thereto. In addition, the command indication area 123 stores data relating to processing to be carried out when no coordinates are detected and the turning-on of the switch in the choosing device 4 is detected (i.e. when the choosing device 4 is clicked on an area outside the location detection range of the tablet 2). For example, in FIG. 8, the X-coordinate range of the region 25A is 200-215, the Y-coordinate range is 240-250, and the corresponding command is “cancel”. Referring now to FIGS. 7 and 8, the choosing device 4 and tablet 2 are described.

As is shown in FIG. 7, electrodes 36A and 36B are normally kept in a non-contact state (the OFF state of switch 36) by means of spring 34. When characters are written or locations are pointed by means of the choosing device 4, a pen tip 32 is pushed against the force of spring 34 and consequently the electrodes 36A and 36B are brought in contact (the ON state of switch 36). Irrespective of whether the choosing device is situated within the coordinate detection range of the transparent tablet 2. The contact/non-contact data of electrodes 36A and 36B (On/OFF state of switch 36) is transmitted to the CPU 11 through the tablet controller 17.

When the choosing device 4 is situated on the transparent tablet 2, the coordinates of the location of the tip 32 of the choosing device 4 are detected by electrostatic induction occurring between the tip 32 of the choosing device and the tablet 2. The process of detection is illustrated in FIG. 8. The coordinates are transmitted to the CPU 11 through the tablet controller 17.

The CPU 11 detects input data, on the basis of the coordinates detected by the transparent tablet 2 and the switching data obtained from the choosing device 4. In other words, the CPU 11 determines, as input data, the coordinates obtained when the switching data has been changed from “OFF” state to “ON” state.

The operation of the information processing apparatus having the display/input device of the structure shown in FIGS. 4 to 8 will now be described.

On the basis of the coordinates of the location of the tip 32 of choosing device 4 and switching data, the CPU 11 detects input data. Specifically, the coordinates obtained when the switching data has been change.

When the coordination of the location of the tip 32 of the choosing device 4, which are obtained when the switching data has been changed from an “OFF” state to an “ON” state, are within the display range of the LCD 3, the CPU 11 starts processing the selected item or input command pointed by the pen 4.

If no coordinates are detected when the switching data has been changed from “OFF” state to “ON” state, the CPU 11 executes the “cancel” processing on the basis of the data set in the command indication area 123 in the RAM 12. More specifically, if the tip 32 of the choosing device 4 points that area on the transparent tablet 2, which is outside the coordinate detection range, the CPU 11 executes the “cancel” processing. In the data input wait state, the CPU 11 always receives the coordinates pointed by the choosing device 4 and the switching data. Thus, in accordance with the specific state in which the coordinates are not detected and the switch is turned on, the specific processing such as “cancel” can be performed. As a result, the quantity of data to be input or displayed on the screen can be increased.

What is claimed:

1. A device for choosing a point on an object comprising:
transparent display means; and
choosing means,
wherein the object is viewed through said transparent display means, and
wherein said point is associated with said choosing means, and
wherein a location of said point is communicated between said device and a computer.

2. The device of claim 1, wherein said association is accomplished visually.

3. The device of claim 2, wherein said transparent display means is a liquid crystal display.

4. The device of claim 3, wherein said choosing means is a cursor movably displayed on said transparent display means.

5. The device of claim 4, wherein said liquid crystal display, displays an image in said location.

6. The device of claim 5, wherein said device further comprises:
a holder,
wherein the said object is placed between said transparent display means and said holder.

7. The device of claim 1, further comprising:
a light source;
wherein light from said light source is reflected off of said object to an eye of a user.

8. The method of choosing a point on an object using the device of claim 1.

9. A device for creating an image on an object comprising:
a computer;
display means;
character input means; and
printing means,
wherein an image of said object is electronically scanned into said computer as a background on said display means, and
wherein said character input means inputs characters which, through suitable word processing software, are superimposed over said background in desired locations, and said printing means prints said characters on said object in said desired locations.

10. The method of creating an image on an object using the device of claim 9.

11. A device for choosing a point on an object comprising:
transparent input means;
transparent display means; and
choosing means,
wherein the object is viewed through said transparent input means and said transparent display means, and
wherein said point is associated with said choosing means, and
wherein a location of said point is communicated between said device and a computer.

12. The device of claim 11, wherein said association is accomplished visually.

13. The device of claim 12, wherein said transparent display means is a liquid crystal display.

14. The device of claim 13, wherein said choosing means is a cursor movably displayed on said transparent display means.

15. The device of claim 14, wherein said liquid crystal display, displays said cursor in said location.

16. The device of claim 15, wherein said device further comprises:
a holder,
wherein the said object is placed between said transparent display means and said holder.

17. The device of claim 16, further comprising:
a light source;
wherein light from said light source is reflected off of said object to an eye of a user.

18. The method of choosing a point using the device of claim 11.

19. The method of claim 18, further comprising the steps of:
typing characters onto said display means using suitable software;
placing said object into a printer; and
printing said characters on said object.
